(19) United States
(12) Patent Application Publication
(10) Pub. No.: US 2012/0005063 A1
(43) Pub. Date: Jan. 5, 2012

(54) FIX PROXY SERVER

(75) Inventors: Robert Manuel Moitoso, Holmdel, NJ (US); Donald Patrick Henderson, Tinton Falls, NJ (US); Thomas Scott Fitzpatrick, Windham, NH (US); Steven Edward Schiff, Montclair, NJ (US)

(73) Assignee: NYSE Euronext, New York, NY (US)

(21) Appl. No.: 13/150,403

(22) Filed: Jun. 1, 2011

Related U.S. Application Data
(60) Provisional application No. 61/360,006, filed on Jun. 30, 2010.

(51) Int. Cl. G06F 15/173; G06Q 40/00

(52) U.S. Cl. 705/37; 709/223

(57) ABSTRACT

Using a feed backbone computer network, enables connection of counterparty customers in disparate Financial Information Exchange (FIX) networks, across IP network boundaries. The feed backbone network links consumer, database, management, and proxy computer systems with a FIX backbone computer network in turn connected to trading extranets via access centers. Proxy computer systems balance their shared message processing load, log message traffic, manage operational sessions, and collect and present aggregated feed information to client users, whether connected locally or to the trading extranets. A software proxy acts as a “middleman” between the two customer endpoints. Copies selected FIX messages to a multicast backbone for aggregation in a standard format. The entire network is centrally configurable and supports realtime operational status.

### CROSS-REFERENCE TO RELATED APPLICATIONS

This application claims the benefit of the priority date of U.S. Provisional patent application Ser. No. 61/360,006, filed Jun. 30, 2010.

### FIELD OF THE INVENTION

The present invention relates to computer network technology. More particularly, the present invention relates to computers used as information servers in financial information networks.

### BACKGROUND OF THE INVENTION

The classic solution to the problem of interconnecting financial information network (FIX) counterparties directly is via a point to point IP network. This allows two counterparties who are connected to the same IP network to communicate via FIX. The market for point-to-point FIX connectivity traditionally has been served by network providers, providing private network services to the financial community (e.g., BT Radianz, TNS, Savvis). These private networks are billed as FIX networks, however, they are fundamentally little more than traditional IP or dedicated lines perhaps with a higher SLA offering or packaged router/circuit redundancy.

The connection of counterparties within private networks provides a healthy commercial incentive to set up and operate such networks in competition with each other. The competition helps drive the providers to better performance and richer service offerings, and these advantages motivate the provision of competing private separately as one of the teachings of the prior art. Separate private networks, however, have the disadvantage of placing barriers to trade among counterparties not sharing the same network. The barriers to trade include performance impacts due to crossing network boundaries and duplication of costs for trading parties needing access to multiple private networks. Consequently there exists motivation for developing an efficient and less-costly means for interconnecting FIX counterparties across the boundaries of the private networks to which they subscribe.

### SUMMARY OF THE INVENTION

Using a feed backbone computer network, the present invention connects counterparty customers in disparate Financial Information Exchange (FIX) networks, across IP network boundaries. The invention's feed backbone network links the invention's consumer, database, management, and proxy computer systems with a FIX backbone computer network in turn connected to trading extranets via access centers. The invention's proxy computer systems balance their shared message processing load, log message traffic, manage operational sessions, and collect and present aggregated feed information to client users, whether connected locally or to the trading extranets. The invention's software proxy acts as a “middleman” between the two customer endpoints. The invention also copies selected FIX messages to a multicast backbone for aggregation in a standard format. The entire network of the invention is centrally configurable and supports real time operational status.

In one embodiment, the invention provides for connecting customers in disparate financial information exchange networks. The invention includes a first backbone computer network and one or more financial information exchange proxy computer systems connected to the first backbone computer network. Also connected to the first backbone computer network are one or more financial information exchange database and management computer systems. One or more information consumer computer systems are connected to the first backbone computer network and a financial information exchange backbone computer network is connected to the first backbone computer network.

The financial information exchange backbone computer network can include one or more access center computer systems. Each of these can further include a computer processor subsystem, a computer memory subsystem, a computer storage subsystem, and a computer communications subsystem. In this embodiment, high-speed interconnections can be provided among the access center computer systems.

In another embodiment, each financial information exchange proxy computer system can include one or more computer processors, a computer memory subsystem, a computer storage subsystem and a computer communications subsystem. Each also can include a set of one or more computer application programs operating via the one or more computer processors and providing services to the users of the financial information exchange proxy computer system and high-speed interconnections among the access center computer systems. The set of one or more computer application programs can include a financial information exchange computer program for logging message traffic among financial information exchange proxy computer systems. It can also include one or more computer programs for collecting and presenting aggregated feed information from financial information exchange proxy computer systems, one or more computer programs for managing financial information exchange proxy computer system and network configuration and one or more computer programs for managing financial information exchange proxy computer system operational sessions.

In one embodiment, the one or more computer programs for collecting and presenting aggregated feed information can include one or more program components for aggregating financial information exchange data from point to point connections in real time to produce said aggregated feed information. The one or more computer programs can also include one or more program components for publishing the feed information to a feed backbone network in real time in a standardized format and one or more program components providing customer control of activation and deactivation of message capture. One or more program components for providing aggregated feed information to multiple customers and one or more program components for configuring the transmission of connection traffic to multicast processes can also be included.

The standardized format can include a elements to contain identifiers of the sender of a message, of the receiver of a message, of the message type; and of the symbol of a message. The aggregated feed information from financial information exchange proxy computer systems can include one or more financial information exchange-protocol application messages and one or more financial information exchange-protocol administrative messages. The one or more computer programs for managing financial information exchange proxy computer system operational sessions can include one or more user connection event processing program components, one or more user disconnection event processing program components and one or more financial information exchange connection status management program components.

The one or more computer programs for managing financial information exchange proxy computer system and network configuration can include one or more program components for balancing message processing load among financial information exchange proxy computer systems, one or more program components for throttling message processing load within a financial information exchange proxy computer system, and one or more program components for logging operational events and proxy connection traffic. The one or more computer programs for managing financial information exchange proxy computer system and network configuration can also include one or more program components for bringing service-providing hosts in and out of active service without affecting the state of existing customer connections, one or more program components for bringing service-providing proxy connections in and out of active service without affecting the state of other customer connections and one or more program components for maintaining connectivity between client counterparty endpoints.

In some embodiments, the one or more external financial information exchange networks are connected to the financial information exchange backbone computer network, and one or more financial information exchange client computer systems are connected to the one or more external financial information exchange networks. The first backbone computer network can be connected to a central configuration computer system. The first backbone computer network can also be connected to a monitoring and data warehousing agent computer system.

In another embodiment of the invention, a method is provided for connecting customers in disparate financial information exchange networks. The method can include constructing and operating a first backbone computer network. One or more financial information exchange proxy computer systems can be connected to the first backbone computer network. One or more financial information exchange database and management computer systems can be connected to the first backbone computer network. Also one or more information consumer computer systems can be connected to the first backbone computer network and a financial information exchange backbone computer network can be connected to the first backbone computer network. The method can also include processing trade and trade-related transactions between customers in disparate financial information exchange networks and processing transactions concerning network and computer system administration.

The method can include connecting one or more access center computer systems to the financial information exchange backbone computer network and interconnecting the access center computer systems with high-speed connections. Also, the method can include connecting one or more external financial information exchange networks to the financial information exchange backbone computer network and connecting one or more financial information exchange client computer systems to any of the one or more external financial information exchange networks. The method can further include logging message traffic among financial information exchange proxy computer systems and collecting and presenting aggregated feed information from financial information exchange proxy computer systems.

In some embodiments, the method includes aggregating financial information exchange data from point to point connections in real time to produce said aggregated feed information, publishing the feed information to a feed backbone network in real time in a standardized format providing customer control of activation and deactivation of message capture, providing aggregated feed information to multiple customers and configuring the transmission of connection traffic to multicast processes. In some embodiments, the method also includes managing financial information exchange proxy computer system and network configuration and managing financial information exchange proxy computer system operational sessions.

The step of managing financial information exchange proxy computer system and network configuration can include balancing message processing load among financial information exchange proxy computer systems, throttling message processing load within a financial information exchange proxy computer system and logging operational events and proxy connection traffic. This step can also include bringing service-providing hosts in and out of active service without affecting the state of existing customer connections, bringing service-providing proxy connections in and out of active service without affecting the state of other customer connections and maintaining connectivity between client counterparty endpoints. The step of managing financial information exchange proxy computer system operational sessions can include one or more user connection event processing program components, one or more user disconnection event processing program components and one or more financial information exchange connection status management program components.

### BRIEF DESCRIPTION OF THE DRAWINGS

FIG. 1 shows the stages of a normal operational scenario (use case).

FIG. 2 shows the stages of the operational scenario triggered when an endpoint becomes unavailable.

FIG. 3 shows the behavior of the invention's load balancing component in distributing connection load among host computers running the Lightning Proxy.

FIG. 4 shows the invention's processing of messages to its log during message processing.

FIG. 5 shows the use of the invention's message feed by a feed application user.

FIG. 6 shows the addition of a Lightning session.

FIG. 7 shows the modification of a Lightning session.

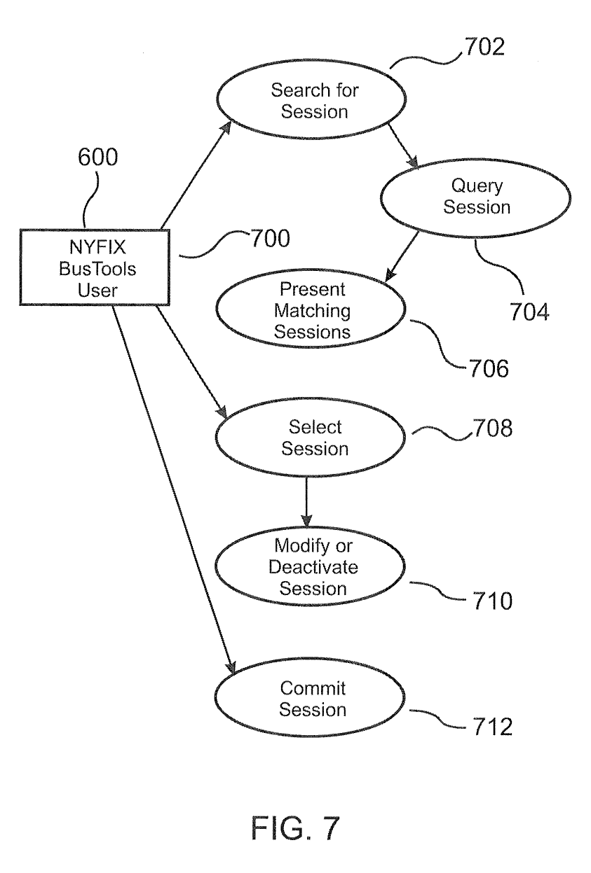

FIG. 8 shows the organization of disparate networks to connect FIX customers using the SFTI FIX backbone.

FIG. 9 shows the organization within the SFTI FIX backbone of the Lightning feed backbone, and the connections to clients using the Lightning feed.

### DETAILED DESCRIPTION OF THE PRESENT INVENTION

The present invention, herein also termed the NYFIX FIX Marketplace, is a “hub and spoke” FIX network, allowing a single connection to route FIX protocol messages to multiple defined destinations. Recovery, protocol transformations, and other value added services (e.g., Safestore) comprise components of the invention, allowing clients to effectively outsource their FIX connectivity to a stock exchange, for example NYSE (the New York Stock Exchange).

In some circumstances, a Marketplace customer also may maintain point-to-point FIX connectivity using any of the aforementioned private FIX network service providers. The invention creates a service offering that differentiates itself from the prior art and creates a value proposition beyond those offerings available from the crowded and commoditized network services market.

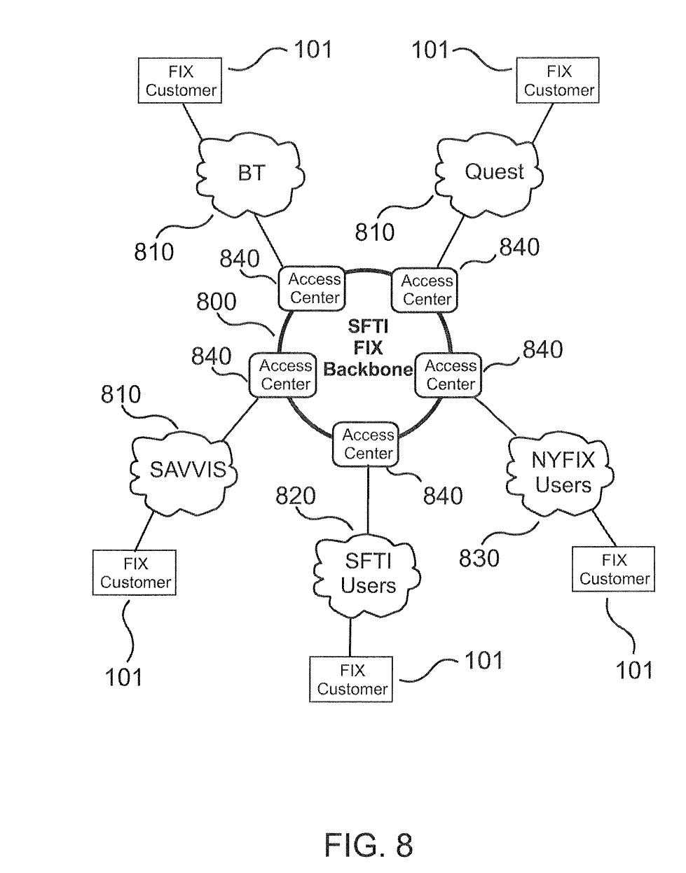

The invention's point-to-point FIX connectivity service accomplishes the following (see FIG. 8):
Connects customers 101 on disparate financial extranets. The extranets 810 shown include, but are not restricted to, BT, Quest, and SAVVIS.
Avoids reliance on a single communication vendor for connectivity.
Maintains low latency at high message rates.
Provides maximum service level availabilities.
Creates opportunities for value-added services that may be offered as managed services to its users.

Also included in the set of extranets are the Secure Financial Transaction Infrastructure (SFTI) users 820, and NYFIX 830. All extranets 810, 820, 830 connect to Secure Financial Transaction Infrastructure (SFTI) FIX network and backbone 800 via access centers 840. Backbone 800 connects to the Lightning Feed backbone.

The invention leverages much of the Marketplace technology base to create a product offering that grows revenues from an untapped requirement for existing and new Marketplace customers, while also creating future product opportunities and leverage.

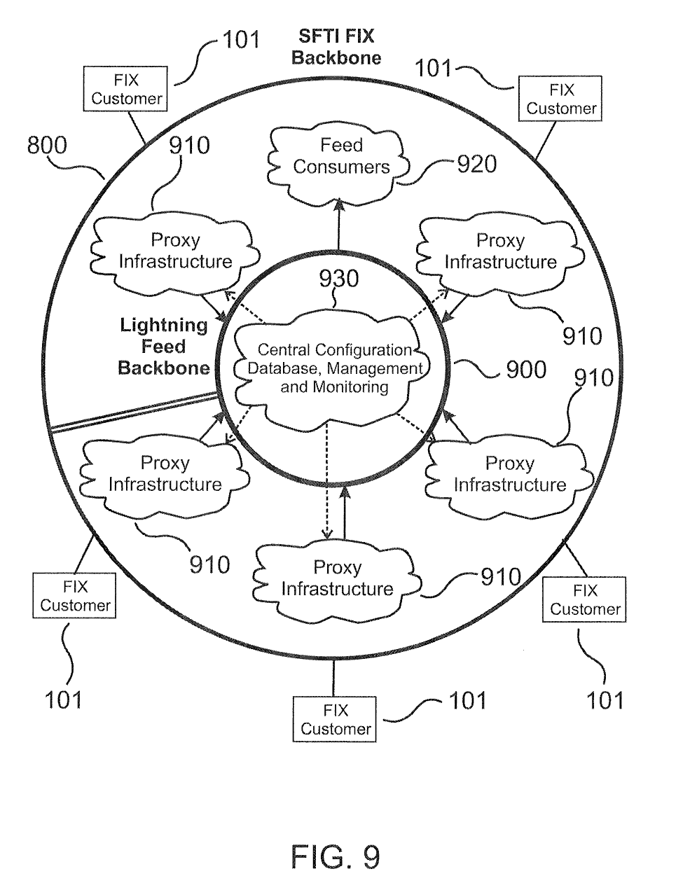

See FIG. 9. Within the SFTI FIX backbone 800, the invention comprises one or more FIX IP proxies 910 connected in a network via a Lightning proxy feed backbone 900, and serving Lightning feed consumers 920. Backbone 900 connects to SFTI FIX backbone 800. A proxy 910 accepts a connection to a trading party 101 or other financial endpoint at one end of its pipe, and creates a connection to another configured endpoint 101, becoming the middleman in a FIX point-to-point session. This connection allows events (session up, connect, disconnect) and FIX traffic to be forwarded onto the invention's multicast network, also termed herein “Lightning Feed”. The multicast network, comprising the invention's connections to financial endpoints and one or more feed backbone connections for traffic concentration and management using the central database and management system 930, represents the aggregation of all of the invention's proxies and their traffic.

The invention's proxies 910 publish information to the feed backbone 900 in a standard way, allowing any application that can receive multicast to filter traffic by the receiver, sender, message type, or symbol (and conceivably other criteria) for Lightning feed consumers 920.

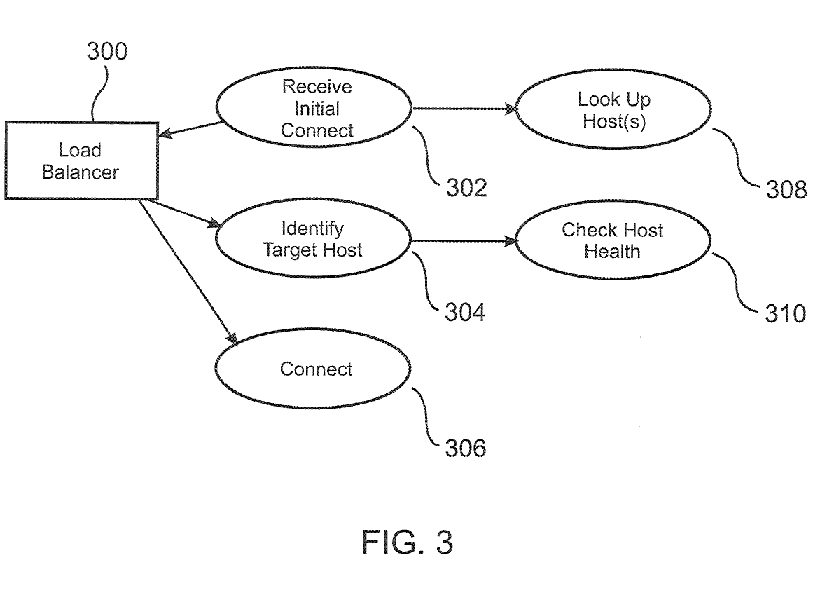

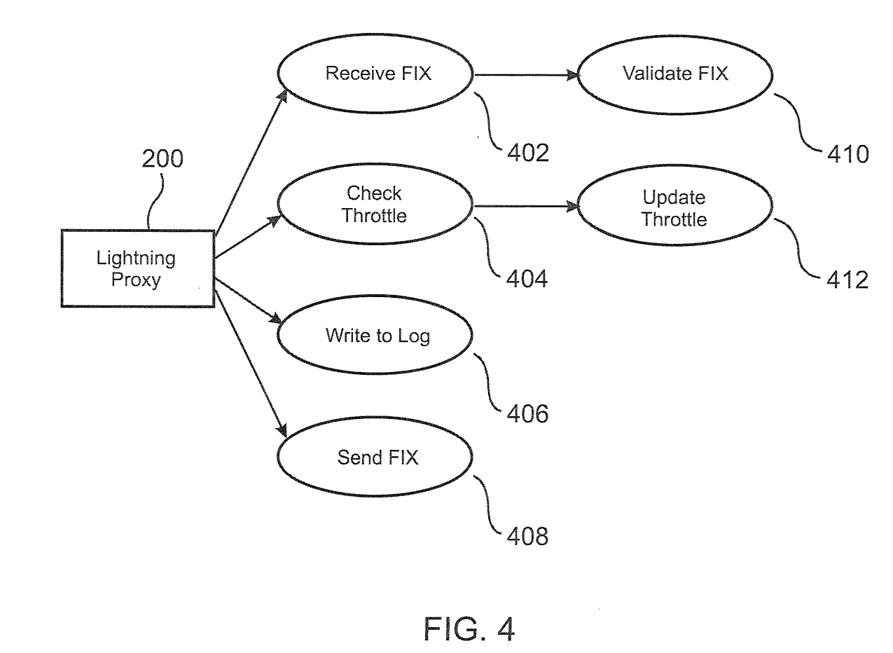

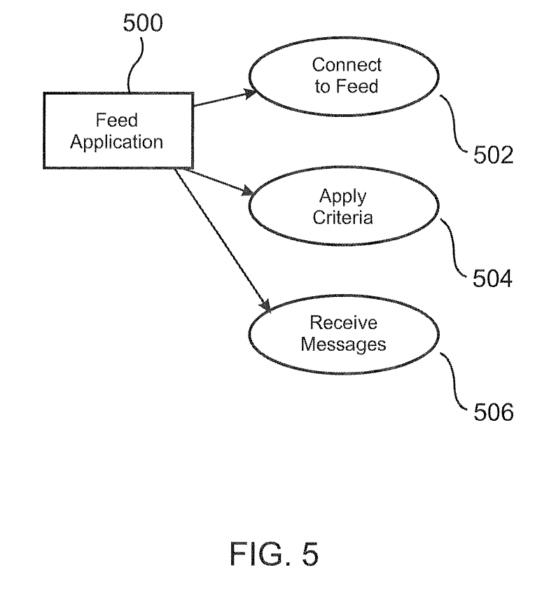

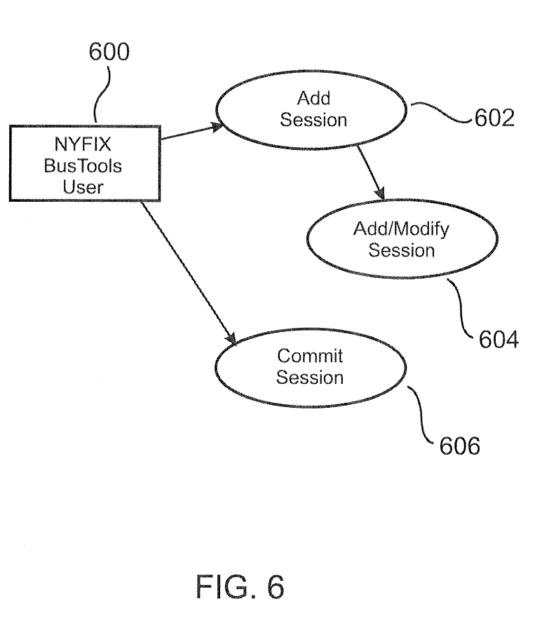

Specific examples of the value-added services of the invention include:
load-balancing software application for distributing connection load among its proxy systems (See FIG. 3);
message logging software application for publishing a trail of transactions between counterparties (See FIG. 4);
message feed subscription software application for collecting and presenting aggregated feed information from its proxy systems (See FIG. 5);
session management software application for adding, modifying, or deleting proxy operation sessions (See FIGS. 6 & 7).

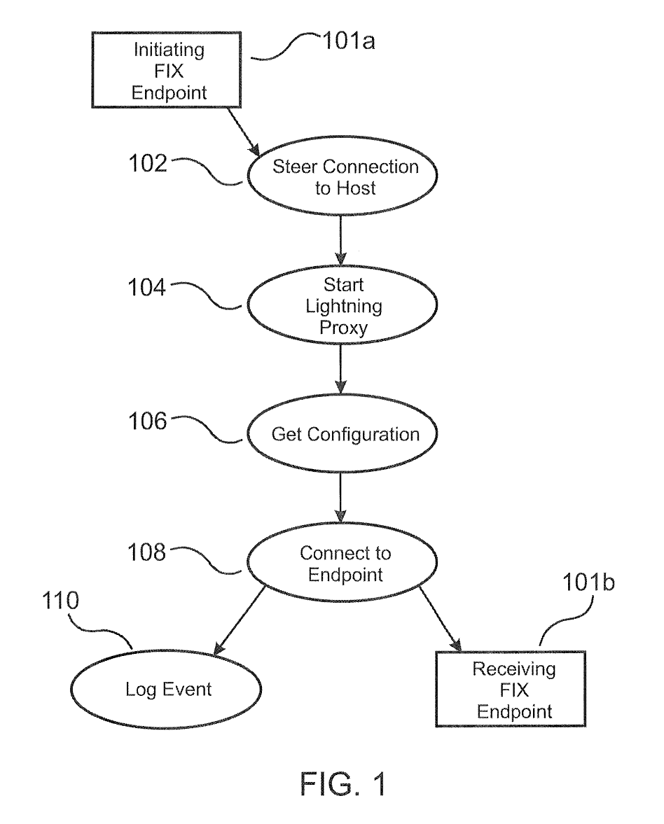

The invention addresses different use cases for its value-added services depending on the requirements of its users and operators. See FIG. 1 for the normal operational scenario, in which all components and endpoints are online and available. An initiating FIX endpoint 101a starts a session. The Lightning system's load balancing component steers (102) the connection using the client's FIX COMPID (identifying the client) to a common IP and port for the system or center to start (104) the Lightning proxy. The Lightning proxy operates as an instance, a single proxy per FIX session, with no central server or service. The Lightning proxy retrieves (106) configuration information from the Bustalk configuration database using sender and target information as the basis for information lookup. Using the retrieved configuration information, the Lightning proxy connects (108) to the receiving FIX endpoint 101b. Successful connection is logged (110).

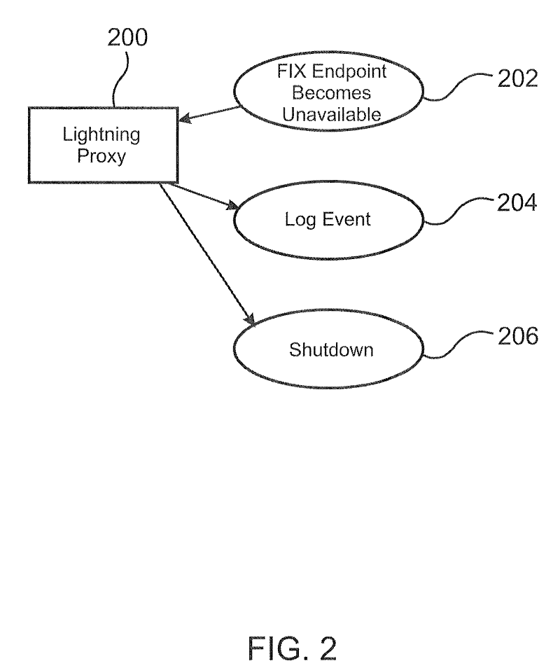

For the case when the requested endpoint becomes unavailable during a session, see FIG. 2. Loss of availability is detected (202) by the Lightning proxy 200 through disappearance of heartbeat messages, network level messaging, or other means well-known in the art. Lightning proxy 200 then logs (204) the loss event with the COMPID/IP address, and triggers (206) an orderly shutdown on both sides of the connection.

The invention balances load among two or more host systems as required. See FIG. 3. The invention's load balancing component 300 receives (302) each initial connect message, and looks up (308) the primary and other hosts serving the connection. The load balancing component 300 identifies (304) the target host, ensures (310) that either the primary host or a failover (backup) host is available to serve the connection, and connects (306) the initiating endpoint to the receiving endpoint based on the status of the hosts.

The invention's Lightning Proxy forwards messages to counterparties while simultaneously logging messages. See FIG. 4 for the publish-feed-message use case. The Lightning Proxy 200 receives (402) a FIX message, and applies a simple validation (410) to the received message to insure it is a FIX message. Full validation is not performed at this stage due to potential performance impacts.

The invention's Lightning Proxy contains a traffic throttle component to restrict traffic volume and balance load under changing network conditions. At the receipt of each message, the proxy checks (404) its throttle and the aggregate message load to insure compliance with the configured maximum messages per second allowed. If the receipt of the message causes the traffic volume to exceed the configured maximum rate, the proxy forces the sender to wait until the configured maximum rate is not exceeded by the sending of that message. Once the message is accepted, the message rate statistics used in the throttle are updated (412).

The proxy writes (406) a log entry for each message in a configured log. The log entry includes the sender ID, receiver ID, message type, and ticker symbol or instrument symbol. Finally the proxy sends (408) the message to its destination.

The invention provides an aggregated feed application component to which users can subscribe. See FIG. 5. The feed application 500 connects (502) to the feed from the Lightning proxies. In a first basic embodiment, the proxies use a simple multicast for transmission to the feed application component. The feed application 500 then screens the proxy feed traffic by applying (504) selection criteria including ticker symbol or instrument symbol, message type, sender ID, and receiver ID. The feed application 500 then sends (506) messages matching the selection criteria to any applications it serves.

The invention supplies a first extension to the NYFIX BusTools graphical user interface (GUI) to manage Lightning proxy sessions. The invention presents the NYFIX BusTools user 600 with the option to add (602) a Lightning session. Adding a Lightning session requires the user to provide computer IDs and the associated reachable IP addresses, along with customer billing code, maximum message rate for throttling traffic, and the identifiers of primary and failure host systems. The invention also provides an Add/Modify option to display, modify, or add (604) a Lightning session and validate the user's inputs. After adding or modifying the Lightning session, using boundary value checks and range checks for validation of inputs, the invention then commits (606) the session.

The invention supplies a second extension to the NYFIX BusTools graphical user interface (GUI) to modify or delete Lightning proxy sessions. The invention presents the NYFIX BusTools user 600 with the option to search (702, 704) by computer ID or IP address (with option for full or partial matching) for an ongoing Lightning session, with the search returning individually-selectable links for presentation to the user (706). The user selects (708) the desired Lightning session from those presented, and modifies (710) the session's parameters. The invention provides for session deactivation at this point, with the deactivated session deleted as part of periodic system housekeeping. Finally, the invention commits (712) the session in order to provide audit trail and establish appropriate rollback points.

The information collected and stored by the invention via its logging process and its feed application can be leveraged for market monitoring, drop copy, allocation services, data warehousing and trade audit, and other services that require detailed knowledge of order and transactional flow. On a larger scale, informational service offerings are possible, where aggregation of the information could be utilized (e.g., TCA).

From an operational standpoint, the connect/disconnect events, coupled with the proxy's awareness of FIX connection health, enables more granular operational awareness. Operations staff and systems are aware of the invention's connections in a FIX context, beyond IP availability, presenting a significant quality advantage over other providers.

In extended embodiments, the invention includes FIX “hacks” and tag manipulation, or even version transformations, allowing for the kind of value-added services offered in Marketplace to be offered to the point-to-point marketplace.

The invention is loosely coupled with the Marketplace BusTalk environment for the purposes of configuration, allowing for central configuration of the invention's services, as well as for billing-to-production configuration reconciliation.

A TradeScope agent will integrate with the invention's feed. This agent will allow for integration with the TradeScope monitoring and data warehouse products, leveraging existing frameworks and technologies.

In the present invention, a single proxy exists for each point-to-point connection. With respect to customer counterparties, the invention supports a direct (IP) point to point FIX (all FIX versions 4.x and above) connection between two counterparties, emulating the service offered by network providers offering point to point IP connectivity within the limits of their proprietary scope, but offering the advantage of eliminating such limits. The client's IP addressing at either endpoint can be any valid IP address, allowing isolation both from the invention's defined service address space and from the other client endpoint. The invention maps traffic for both end points to specific IP/Port designations, preventing the client from reaching any IP destination or port apart from those configured in the invention. The invention's session is a unique connection between two counterparty endpoints, so that one endpoint may participate in more than one session concurrently. The invention supports a dedicated host model for the customer, meaning that the customer sees only the host and the customer's own counterparties. The invention also supports a shared managed service model.

The invention supports the FIX Unidirectional connection model, in which one side is always the initiator of the TCP session, and the other side is the acceptor.

With respect to its configuration management, the invention brings service-providing hosts in and out of its active service pool for maintenance without affecting the state of existing customer connections. The invention supports independent management of individual proxy connections, so that any proxy connection may be deactivated without affecting others. In the event of a failure of access center, of inter-access center facilities, of application hardware hosts, or of application software, both client counterparty endpoints automatically fail over to a redundant network and software path to restore connectivity. The invention's proxy supports configurable throttling in messages per second. The invention supports logging of operational events for integration with monitoring systems (ITRS), and a configurable ability to send all traffic carried over the connection to a log file.

With respect to its information feeds and data aggregation, the invention supports creation of a consolidated realtime feed of FIX data which is aggregated from point to point connections, and consolidation of point to point FIX data in order to collect and aggregate all data traversing point to point network and build value added service offerings internally and with partners. The invention also supports customer control of activation and deactivation of messages capture, the aggregated feed of all lightning sessions to support multiple consumers, and the configurable ability to send all traffic carried over the connection to multicast processes.

As will be apparent to those skilled in the art in light of the foregoing disclosure, many alterations and modifications are possible in the practice of this invention without departing from the spirit or scope thereof.

We claim:

1. An apparatus for connecting customers in disparate financial information exchange networks, comprising:
a first backbone computer network;
one or more financial information exchange proxy computer systems connected to the first backbone computer network;
one or more financial information exchange database and management computer systems connected to the first backbone computer network;
one or more information consumer computer systems connected to the first backbone computer network; and
a financial information exchange backbone computer network connected to the first backbone computer network.

2. The apparatus of claim 1, in which the financial information exchange backbone computer network comprises:
one or more access center computer systems, each further comprising a computer processor subsystem, a computer memory subsystem, a computer storage subsystem, and a computer communications subsystem; and
high-speed interconnections among the access center computer systems.

3. The apparatus of claim 1, in which each financial information exchange proxy computer system comprises:
one or more computer processors;
a computer memory subsystem;
a computer storage subsystem;
a computer communications subsystem;
a set of one or more computer application programs operating via the one or more computer processors and providing services to the users of the financial information exchange proxy computer system; and
high-speed interconnections among the access center computer systems.

4. The apparatus of claim 3, in which the set of one or more computer application programs comprises:
financial information exchange computer program for logging message traffic among financial information exchange proxy computer systems;
one or more computer programs for collecting and presenting aggregated feed information from financial information exchange proxy computer systems;
one or more computer programs for managing financial information exchange proxy computer system and network configuration; and
one or more computer programs for managing financial information exchange proxy computer system operational sessions.

5. The apparatus of claim 4, in which the one or more computer programs for collecting and presenting aggregated feed information comprise:
one or more program components for aggregating financial information exchange data from point to point connections in real time to produce said aggregated feed information;
one or more program components for publishing said feed information to a feed backbone network in real time in a standardized format;
one or more program components providing customer control of activation and deactivation of message capture;
one or more program components for providing aggregated feed information to multiple customers; and
one or more program components for configuring the transmission of connection traffic to multicast processes.

6. The apparatus of claim 5, in which the standardized format comprises:
an element to contain an identifier of the sender of a message;
an element to contain an identifier of the receiver of a message;
an element to contain an identifier of the message type; and
an element to contain an identifier of the symbol of a message.

7. The apparatus of claim 4, in which the aggregated feed information from financial information exchange proxy computer systems comprises:
one or more financial information exchange-protocol application messages; and
one or more financial information exchange-protocol administrative messages.

8. The apparatus of claim 4, in which the one or more computer programs for managing financial information exchange proxy computer system operational sessions comprise:
one or more user connection event processing program components;
one or more user disconnection event processing program components; and
one or more financial information exchange connection status management program components.

9. The apparatus of claim 4, in which the one or more computer programs for managing financial information exchange proxy computer system and network configuration comprise:
one or more program components for balancing message processing load among financial information exchange proxy computer systems;
one or more program components for throttling message processing load within a financial information exchange proxy computer system;
one or more program components for logging operational events and proxy connection traffic;
one or more program components for bringing service-providing hosts in and out of active service without affecting the state of existing customer connections;
one or more program components for bringing service-providing proxy connections in and out of active service without affecting the state of other customer connections; and
one or more program components for maintaining connectivity between client counterparty endpoints.

10. The apparatus of claim 1, in which one or more external financial information exchange networks is connected to the financial information exchange backbone computer network, and one or more financial information exchange client computer systems is connected to the one or more external financial information exchange networks.

11. The apparatus of claim 1, in which the first backbone computer network is connected to a central configuration computer system.

12. The apparatus of claim 1, in which the first backbone computer network is connected to a monitoring and data warehousing agent computer system.

13. A method for connecting customers in disparate financial information exchange networks, comprising the steps of:
constructing and operating a first backbone computer network;
connecting one or more financial information exchange proxy computer systems to the first backbone computer network;
connecting one or more financial information exchange database and management computer systems to the first backbone computer network;
connecting one or more information consumer computer systems to the first backbone computer network;
connecting a financial information exchange backbone computer network to the first backbone computer network;
processing trade and trade-related transactions between customers in disparate financial information exchange networks; and
processing transactions concerning network and computer system administration.

14. The method of claim 13, further comprising the steps of:
connecting one or more access center computer systems to the financial information exchange backbone computer network; and
interconnecting the access center computer systems with high-speed connections.

15. The method of claim 13, further comprising the steps of:
connecting one or more external financial information exchange networks to the financial information exchange backbone computer network; and
connecting one or more financial information exchange client computer systems to any of the one or more external financial information exchange networks.

16. The method of claim 13, in which the step of processing trade and trade-related transactions between customers in disparate financial information exchange networks comprises the steps of:
logging message traffic among financial information exchange proxy computer systems; and
collecting and presenting aggregated feed information from financial information exchange proxy computer systems.

17. The method of claim 16, in which the step of collecting and presenting aggregated feed information comprises the steps of:
aggregating financial information exchange data from point to point connections in real time to produce said aggregated feed information;
publishing said feed information to a feed backbone network in real time in a standardized format;
providing customer control of activation and deactivation of message capture;
providing aggregated feed information to multiple customers; and
configuring the transmission of connection traffic to multicast processes.

18. The method of claim 13, in which the step of processing transactions concerning network and computer system administration comprises the steps of:
managing financial information exchange proxy computer system and network configuration; and
managing financial information exchange proxy computer system operational sessions.

19. The method of claim 18, in which the step of managing financial information exchange proxy computer system and network configuration comprises the steps of:
balancing message processing load among financial information exchange proxy computer systems;
throttling message processing load within a financial information exchange proxy computer system;
logging operational events and proxy connection traffic;
bringing service-providing hosts in and out of active service without affecting the state of existing customer connections;
bringing service-providing proxy connections in and out of active service without affecting the state of other customer connections; and
maintaining connectivity between client counterparty endpoints.

20. The method of claim 18, in which the step of managing financial information exchange proxy computer system operational sessions comprise:
one or more user connection event processing program components;
one or more user disconnection event processing program components; and
one or more financial information exchange connection status management program components.
